(19) United States
(12) Patent Application Publication
(10) Pub. No.: US 2007/0108107 A1
(43) Pub. Date: May 17, 2007

(54) DISPOSABLE PRE-TENSIONED SIEVE FRAME AND METHOD OF MAKING SAME

(76) Inventor: Deborah E. MORROW, Independence, MO (US)

Correspondence Address: SPENCER, FANE, BRITT & BROWNE, 1000 WALNUT STREET, SUITE 1400, KANSAS CITY, MO, 64106-2140, US

(21) Appl. No.: 11/419,309

(22) Filed: May 19, 2006

Related U.S. Application Data
(60) Provisional application No. 60/736,988, filed on Nov. 15, 2005.

(51) Int. Cl. B07B 1/49

(52) U.S. Cl. 209/405

(57) ABSTRACT

A disposable sieve frame (10) comprising a body structure (12) constructed from one or more layers of a synthetic material, and a pre-tensioned screen (14) constructed from a synthetic or metal material and secured by a chemical adhesive or a layer of melted material or by melting the screen material to a perimeter member (16) and an interior member (18) of the body structure (12) so as to result in a substantially flat sifting surface, and a method of making the same.

### RELATED APPLICATIONS

The present non-provisional patent application claims priority benefit with regard to all common subject matter of an earlier-filed provisional patent application titled “Disposable Pre-Tensioned Sieve Frame”, Ser. No. 60/736,988, filed Nov. 15, 2005. The identified earlier-filed patent application is hereby incorporated by reference into the present patent application.

### BACKGROUND OF THE INVENTION

1. Field of the Invention

The present invention is related to sieve frames, such as are used in flour milling, and methods of making them. More specifically, the present invention concerns a disposable sieve frame comprising a body structure constructed from one or more layers of a synthetic material, and a pre-tensioned screen constructed from a synthetic or metal material and secured by a chemical adhesive or a layer of melted material or by melting the screen material to a perimeter member and an interior member of the body structure so as to result in a substantially flat sifting surface, and a method of making the same.

2. Description of Related Art

Sieve frames are installed in sieve boxes which are, in turn, installed in plan sifters which are used to sift or sort products or materials. Plan sifters are used, for example, to sift flour during flour milling. Sieve frames are available with wooden or metal frames. Screening material, which may be synthetic or metal, is secured to the frames using adhesive or staples. Sieve frames that use adhesive to secure the screen are called “glue-on” frames; sieve frames that use staples to secure the screen are called “staple-on” frames. The frames are reused by removing and replacing the screen when it wears out, when a different type of screen material is required, and/or during scheduled maintenance.

For glue-on frames, replacing the screen involves the following steps. First, the frame is prepared as follows. The damaged screen and felt stripping are removed from the frame. The frame is then soaked in an acetone bath to loosen dried adhesive, and then thoroughly scrubbed with a stiff brush using surfactant and water. If the frame is metal, the frame is then bead-blasted to remove any remaining adhesive and to create a smooth surface. The felt stripping is then replaced. Next, the new screen is attached to the prepared frame as follows. Properly-sized clamps are selected based upon the overall size of the frame. Support blocks are then positioned on each of the clamps to hold the frame at a level height that is even with the clamp. The frame is then placed on top of the support blocks, and the screen is placed on top of the frame. The clamps are then manually closed. The screen is then adjusted as needed and galvanized weight bars are placed in each open section of the frame on top of the screen. Pneumatic tension is then applied; the tension is checked using a tension-measuring device, and the tension is adjusted as needed via pneumatic control. A chemical adhesive in liquid form is then applied to the perimeter and interior members of the frame to fully encapsulate the screen in order to bond it to the frame. A quick-drying activator is then sprayed onto the adhesive. Then the weight bars are removed, the pneumatic tensioning is removed, and the clamps are released. The adherence and tensioning is then checked. If the screen is not adhered correctly to the frame, or if the screen is improperly tensioned, then the screen must be removed and re-attached properly by repeating the foregoing steps. If the screen is adhered correctly and tensioned properly, then any excess screen material can be trimmed, and the sieve frame is ready for use.

For staple-on frames, the screen is attached to the frame using industrial staples. The screen has cloth edging sewn or bonded along its outer perimeter. The cloth edging is positioned within a recessed surface in the frame, and serves as a placeholder guide for installing staples when attaching the screen to the frame. Replacing the screen involves the following steps. The existing screen is removed, and any remaining staples are removed from the frame. The backwire and liner are then visually inspected. New cleaners are then inserted. The cloth edging of a new screen is then placed on the recessed surface, and the screen is stapled to the frame starting at the lower right corner and proceeding to the upper right corner, mid-section right side, lower left corner, mid-section bottom, upper left corner, mid-section left side, and finishing at the mid-section top. At each staple point, screen-stretching pliers are used to pull the screen to maximum tension. Over time, inserting and removing staples degrades the integrity of the wooden tacking area of the frame, causing chipping and cracking to occur. As a result, tension levels can become inconsistent and can create uneven wear areas across the screening material, which can cause premature screen failure.

It will be appreciated that, in both cases, re-screening and other maintenance can be time-consuming and costly, and, furthermore, can require significant downtime for the associated plan sifting or other machinery.

Furthermore, for various reasons, including that wood and metal can expand and contract significantly depending on ambient environmental conditions, prior art sieve frames may not be straight and square, requiring that relatively large tolerances be provided between the sieve frame and the sieve box into which the sieve frame fits. Often, this results in the sieve frame either not fitting into the sieve box or being too loose within the sieve box. When the sieve frame is too loose, the cleaner devices which are used in combination with the sieve frame can slip out of position and become lodged, or immobile, or become absent entirely from one or more sections, thereby rendering the devices ineffectual for that section. When this happens, that section of the sieve frame will blind-over and the associated pan will become clogged with product.

U.S. Pat. No. 6,202,857, discloses a flat sifter frame having a frame constructed from a metal core covered with polyurethane. Polyurethane, by itself, lacks the structural rigidity to withstand the required tension of the screen. The screen is attached to the frame using polyurethane foam applied over the screen along the perimeter and interior members of the frame. This layer of foam creates a raised edge, or lip, along the perimeter and interior members which results in a build-up of particles, causing the screen to blind-over and fail prematurely. The build-up of particles can also promote insect infestation. Furthermore, the cost associated with the materials and manufacturing of this flat sifter frame prohibits simply disposing of the sifter frames when they have become worn, and yet no method is disclosed for re-screening the worn sifter frames.

Due to these and other problems and disadvantages in the prior art, a need exists for an improved sieve frame and an improved method of making sieve frames.

### SUMMARY OF THE INVENTION

The present invention overcomes the above-described and other problems by providing a disposable pre-tensioned sieve frame for use in sifting and sorting operations, such as in sifting flour during flour milling operations, and a method of making the same. In one embodiment, the sieve frame broadly comprises a body structure constructed from a synthetic material and including at least one perimeter member and at least one interior member, and a screen secured in tension to the perimeter member and the interior member and presenting a substantially flat sifting surface.

In a first embodiment of the body structure, the perimeter and interior members are individual members that are assembled to form the body structure. The individual members may be adapted to positively engage each other during assembly, and this engagement may be supplemented with a chemical adhesive. The individual members may each be a composite of a first layer of a first material and a second layer of a second material.

In a second embodiment of the body structure, the body structure is constructed from a single sheet of material into which is created one or more openings to define the perimeter and interior members. The single sheet may be a composite of a first layer of a first material and a second layer of a second material.

The screen may be constructed of a synthetic material or a metal material. The screen may be secured by a chemical adhesive or a layer of melted material or by melting the screen material to the perimeter and interior members of the body structure so as to result in the substantially flat sifting surface.

These and other features of the present invention are discussed in greater detail below.

### BRIEF DESCRIPTION OF THE DRAWING FIGURES

A preferred embodiment of the present invention is described in detail below with reference to the attached drawing figures, wherein:

FIG. 1 is a plan view of a preferred embodiment of the sieve frame of the present invention, wherein a screen component of the sieve frame is shown partially cut-away in order to more clearly show the relationships between various components;

FIG. 1A is a bottom view of the sieve frame of FIG. 1;

FIG. 2 is an isometric view of the sieve frame, showing a substantially flat sifting surface of the sieve frame;

FIG. 3 is a fragmentary isometric view showing a first implementation of a positive connection between first and second members of the sieve frame;

FIG. 4 is a fragmentary isometric view showing a second implementation of the positive connection between the first and second members of the sieve frame;

FIG. 5 is a fragmentary isometric view showing multiple layers in a member of the sieve frame;

FIG. 6 is a table showing illustrative tensioning standards for various micron sizes of a screen of the sieve frame;

FIG. 7 is a plan view of the sieve frame installed in a sieve box;

FIG. 8 is an isometric view of a preferred second embodiment of the sieve frame; and

FIG. 9 is a bottom view of a preferred third embodiment of the sieve frame wherein a second, or bottom, screen component of the sieve frame is shown partially cut-away in order to more clearly show the relationships between various components.

### DETAILED DESCRIPTION OF THE INVENTION

With reference to the figures, a sieve frame 10 and method of making the same is described, shown, and otherwise disclosed in accordance with a preferred embodiment of the present invention. Broadly, the sieve frame 10 of the present invention provides a disposable alternative to re-screenable frames used in sifting and sorting operations, such as in sifting flour during flour milling operations, thereby eliminating problems and costs associated with using and maintaining re-screenable frames.

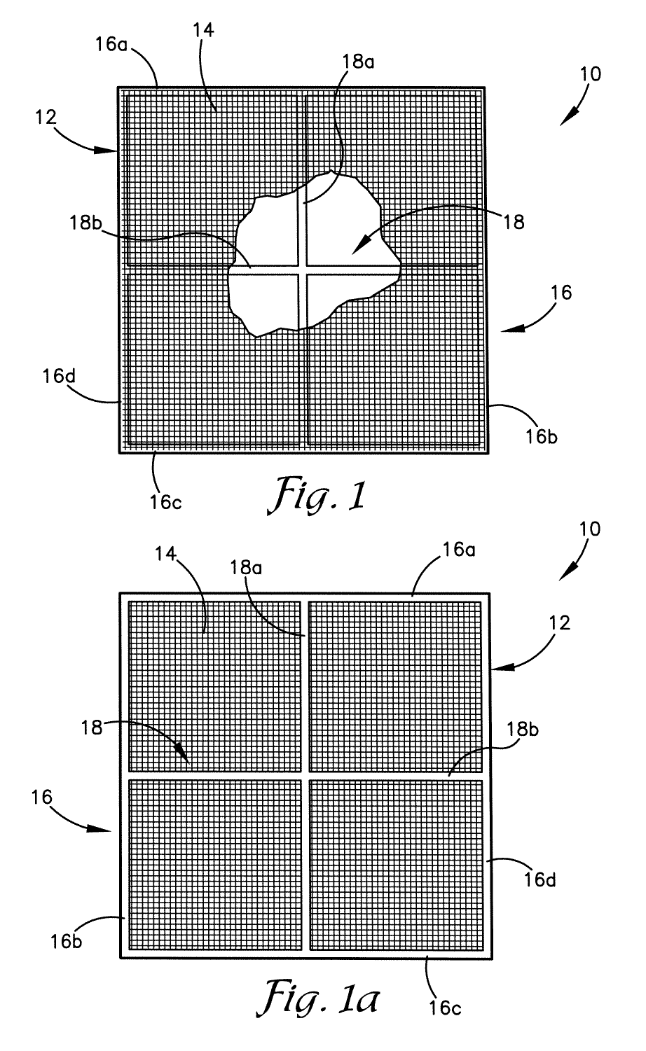

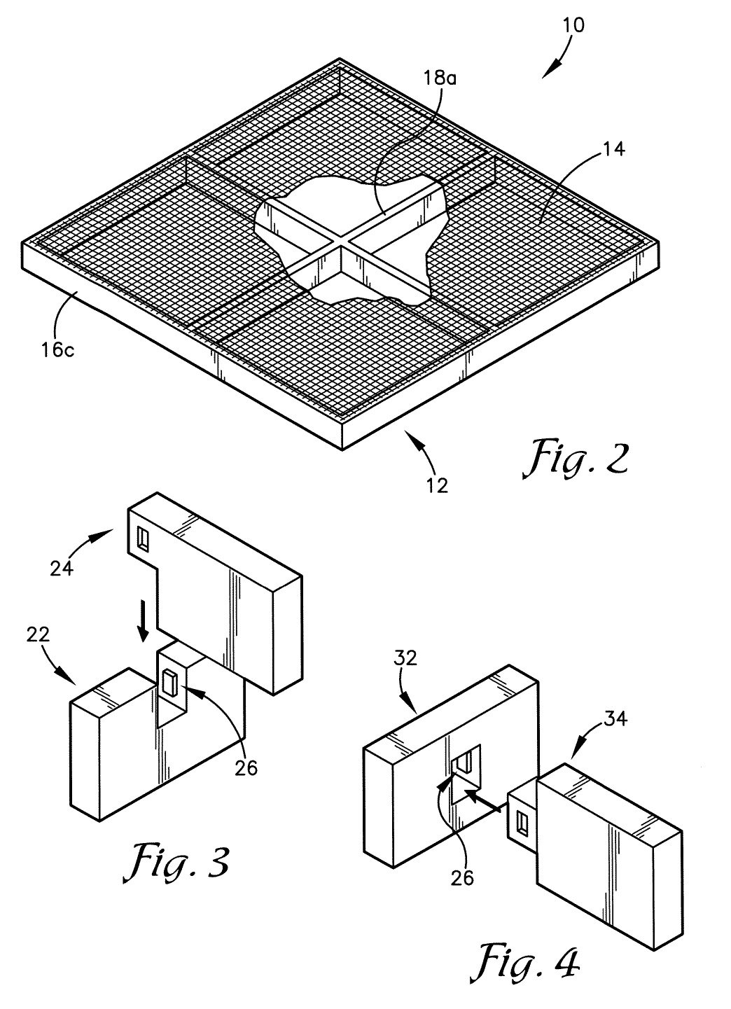

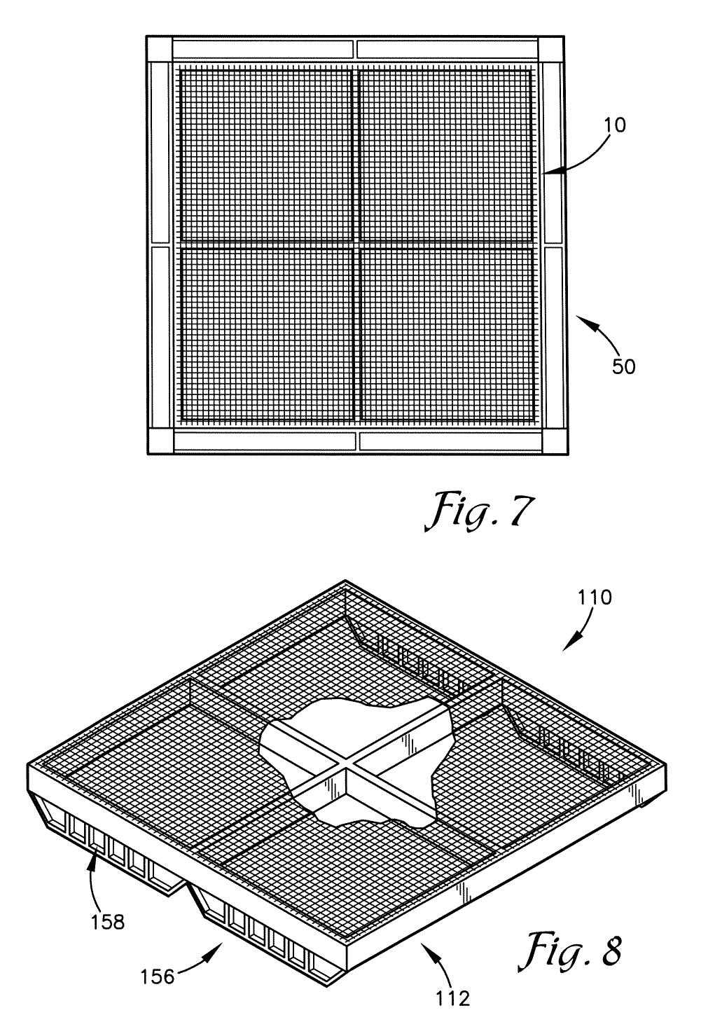

In one embodiment, shown in FIGS. 1 and 1A, the sieve frame 10 comprises a body structure 12 and a pre-tensioned screen 14. All components are constructed from one or more materials approved for use with food, i.e., food-grade materials. The body structure 12 and screen 14 may both be constructed from one or more synthetic materials, such as one or more food-grade plastics. Suitable synthetic materials include, for example, individually or in combination, nylon polyamide 6/6, acrylonitrile butadiene styrene (ABS), and expanded polyvinyl chloride. Use of these or other synthetic materials provides a number of advantages, including, for example, lower cost and lower weight, and a tighter fit between the sieve frame 10 and the sieve box 50 (see FIG. 7) because increased flexibility and decreased susceptibility to expansion and contraction of these materials allows for smaller tolerances. Alternatively, the screen 14 may be constructed from a metal material, such as stainless steel 304, 316, or 430.

The body structure 12 provides support for maintaining the proper shape and tension of the screen 14. The body structure 12 may include at least one perimeter member 16 and at least one interior member 18, or batten. In one contemplated implementation, for example, there are at least four perimeter members 16a,16b,16c,16d and at least two interior members 18a,18b. The actual number of perimeter members 16 and interior members 18 will depend on a number of factors and considerations, including, for example, the size, shape, and method of construction (e.g., molding as a unit or assembly of individual members) of the body structure 12.

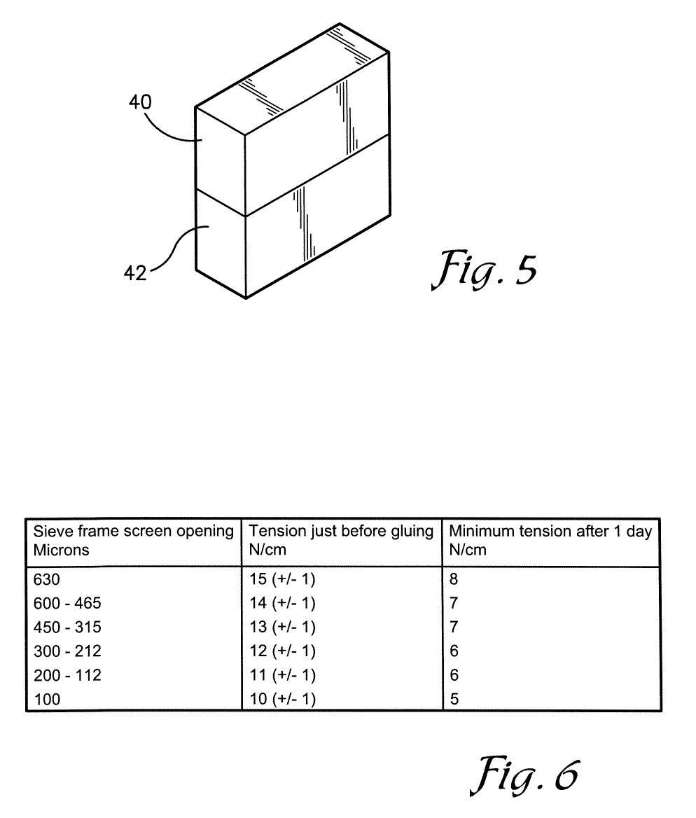

In a first embodiment of the body structure 12, referring also to FIGS. 3 and 4, the body structure 12 includes a plurality of individual members 16a,16b,16c,16d,18a,18b that are assembled to form the perimeter and interior structures. To facilitate such assembly, the end portions and, as needed or desired, intermediate portions, of the individual members 16a,16b,16c,16d,18a,18b are adapted to positively, or mechanically, engage, i.e., “snap” together, or otherwise cooperate with one another. Referring specifically to FIG. 3, the member portions 22,24 are shown cooperating in a half-lap relationship, with each member portion 22,24 presenting one part, i.e., male or female, of an engagement mechanism 26. Referring specifically to FIG. 4, the member portions 32,34 are shown cooperating in a mortise-and-tenon relationship, with the same or a similar two-part engagement mechanism 36. The mechanical engagement may be supplemented with a chemical adhesive, such as a cyanoacrylate adhesive, to increase the rigidity of the of the assembled body structure 12. Additionally, referring also to FIG. 5, the individual members 16a,16b,16c,16d,18a,18b may each be constructed as a composite of multiple layers 40,42 of different materials. The layers 40,42 can be secured together by, for example, a chemical adhesive, such as a cyanoacrylate adhesive, applied between the layers 40,42; a meltable material, such as polyurethane film, applied between the layers 40,42 and melted; or by melting adjacent surfaces of the layers 40,42 in order to fuse them together. The use of multiple layers 40,42 can increase the body structure's rigidity to better support the required tension on the screen 14, while also reducing the total weight of the sieve frame 10.

In a second embodiment of the body structure 12, the body structure 12 is created from a single sheet of material by routing, cutting, sawing, or otherwise mechanically creating openings or otherwise creating openings in the sheet to define the perimeter and interior members 16,18. Referring again to FIG. 5, the single sheet of material may be constructed as a composite of multiple layers 40,42 of different materials. In this implementation, the body structure 12 is created from the multiple layers of material by either securing the layers 40,42 together to create the single sheet and then routing openings in the single sheet to define the perimeter and interior 16,18 members, or, alternatively, by routing openings in the various layers 40,42 to define the perimeter and interior members 16,18 and then securing the routed layers 40,42 together. The layers 40,42 can be secured together in the same manner described above.

In a third embodiment of the body structure 12, the body structure 12 is created by introducing a liquid material into a mold form. Once the liquid cools and solidifies, the body structure 12 can be removed from the mold. The liquid material may include nylon polyamide in the form of a liquid thermoplastic resin, and the resin may be introduced into the mold by pouring. Alternatively, the liquid material may include nylon polyamide in the form of a thermoplastic polymer, and the polymer may be introduced into the mold by injection molding.

For each of the aforementioned embodiments of the body structure 12, the dimensions of the perimeter and interior members 16,18 may vary depending on such considerations as the size of the sieve frame 10 and the actual application in which it will be used. In various alternative implementations, for example, the members 16,18 may be approximately between 0.25 inches and 0.75 inches in thickness; approximately between 0.4 inches and 0.6 inches in thickness; and approximately 0.5 inches in thickness, for a body structure 12 having an outside perimeter of approximately 19 inches wide and approximately 21 inches long, or, for non-rectangular shapes, the substantial equivalent thereof.

The screen 14 allows for selectively sifting or sorting a product or material of interest, such as flour, corn, or cereal grains. The screen 14 has a defined “micron” size, which refers to the size of the openings between the threads of the screen 14. The micron size will depend upon the size of the product or material being sifted or sorted. The tension on the screen 14 will depend on such considerations as the type of material from which the screen 14 is constructed and the micron size. Referring to FIG. 6, for example, illustrative tension standards are shown for a polyamide-nylon screen material of various micron sizes. For a metal material, the illustrative tension standards are approximately 3 N/cm higher for each micron size. Proper tensioning ensures that the micron size is maintained over time and avoids premature failure of the screen 14. Undertensioning the screen can result in, or have the same effect as, a smaller micron size, and, furthermore, can result in wear points and lead to premature failure. Overtensioning can result in an elongation, or stretching, of the threads of the screen which can lead to premature failure.

The screen 14 may be secured to the surfaces of the perimeter and interior members 16,18 of the body structure 12 using a chemical adhesive, such as cyanoacrylate adhesive. Alternatively, the screen 14 may be secured to the surfaces using a meltable material, such as polyurethane film. Alternatively, the screen 14 may be melted to the surfaces so as to fuse the screen 14 and members 16,18 together. Alternatively, recalling the third embodiment of the body structure 12, in which the body structure 12 is created by introducing a liquid material into a mold form, the screen 14 may be molded onto or into the body structure 12. Alternatively, the screen 14 may be secured to the surfaces by ultrasonic or high frequency welding. In all cases, the screen 14 and body structure 12 present a substantially flush, or level, sifting surface, substantially without any lip or other raised area.

In exemplary but non-limiting use, referring also to FIG. 7, the sieve frame 10 is inserted into an otherwise conventional sieve box 50 which is, in turn, used in a plan sifter for flour milling.

Referring to FIG. 8, a preferred second embodiment of the sieve frame 110 is shown which is different from the preferred embodiment described above in at least the following respect: the sieve frame 110 includes a pan guard 156. The pan guard 110 is a spacing structure depending from first and second spaced apart, parallel perimeter members of the body structure 112, and creating a space, or “pan pocket”, between the sieve frame 110 and the sieve box to allow an end user the ability to use conventional pan and screen cleaners. The pan guard 156 may be approximately between 0.5 inches and 3.5 inches in height, depending on the particular application. As shown, openings 158 may be incorporated into the pan guard structure in order to reduce both material and weight. The pan guard 156 may be incorporated into or secured to the perimeter members using any of the above-described methods for constructing the body structure 112.

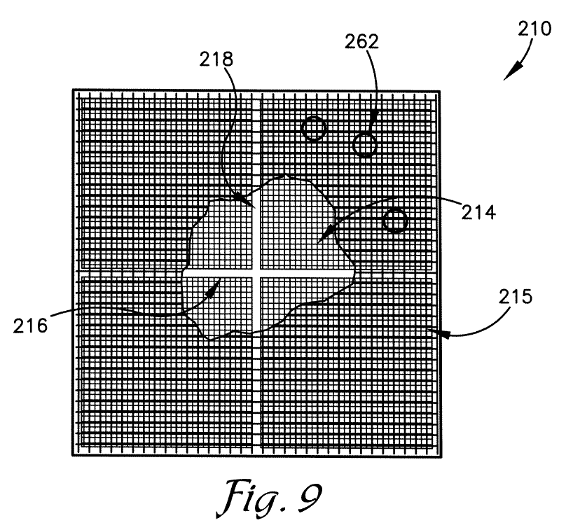

Referring to FIG. 9, a preferred third embodiment of the sieve frame 210 is shown which is different from the preferred embodiments described above in at least the following respect: the sieve frame 210 includes a second, or bottom, screen 215 secured to opposite surfaces of the perimeter and interior members 216,218 as the first, or top, screen 214. The first screen 214 and the second screen 215 cooperate to form a pocket therebetween to hold at least one cleaning element 262. The second screen 215 may be constructed of the same material as or a different material from the first screen 214, may be a heavier backing-type screen with a larger micron size than the first screen 214, and may be secured to the body structure 212 using any of the same securement methods or mechanisms described above for the first screen 214.

From the foregoing discussion, it will be appreciated that the sieve frame of the present invention provides a number of substantial advantages over the prior art, including, for example, that the lighter weight resulting from the use of plastic material(s) decreases the amount of energy needed to operate some plan sifter machinery. Relatedly, the lighter weight provides the option of either maintaining the speed at which the machinery is run to maintain current throughput of product while enjoying lower energy costs, or increasing the speed to enjoy increased throughput while maintaining energy costs. Furthermore, the increased flexibility and decreased susceptibility to expansion and contraction of the plastic material(s) allow for a tighter fit between the sieve frame and the sieve box. Additionally, the use of low cost, disposable materials, and the substantial elimination of maintenance, saves both time and money. Relatedly, the ability to quickly and easily replace sieve frames without time-consuming and costly re-screening or other maintenance reduces downtime and thereby increases throughout/capacity.

Although the present invention has been described with reference to the preferred embodiment illustrated in the drawings, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A sieve frame comprising:
a body structure including a perimeter member and an interior member constructed from a synthetic material; and
a first screen secured in tension to the perimeter member and the interior member and presenting a substantially flat sifting surface.

2. The sieve frame as set forth in claim 1, wherein the perimeter member and the interior member are individual members that are assembled to form the body structure.

3. The sieve frame as set forth in claim 2, wherein the individual members are adapted to positively engage each other.

4. The sieve frame as set forth in claim 3, wherein the positive engagement is supplemented with a chemical adhesive.

5. The sieve frame as set forth in claim 2, wherein the individual members are each a composite of a first layer of a first material and a second layer of a second material.

6. The sieve frame as set forth in claim 1, wherein the body structure is constructed from a single sheet of material into which is mechanically created one or more openings to define the perimeter member and the interior member.

7. The sieve frame as set forth in claim 6, wherein the single sheet of material is a composite of a first layer of a first material and a second layer of a second material.

8. The sieve frame as set forth in claim 7, wherein the first layer and the second layer are secured together by a melted polyurethane film.

9. The sieve frame as set forth in claim 1, wherein the first screen is constructed from a synthetic material.

10. The sieve frame as set forth in claim 1, wherein the first screen is constructed from a metal material.

11. The sieve frame as set forth in claim 1, wherein the first screen is secured to the perimeter member and the interior member by a chemical adhesive.

12. The sieve frame as set forth in claim 1, wherein the first screen is secured to the perimeter member and the interior member by a melted polyurethane film.

13. The sieve frame as set forth in claim 1, further including a second screen secured in tension to an opposite side of the body structure as the first screen, thereby creating a pocket between the first and second screens.

14. A sieve frame comprising:
a body structure including a perimeter member and an interior member constructed from a synthetic material, with the perimeter member and the interior member being individual members that are assembled to form the body structure, and wherein the individual members are adapted to positively engage each other; and
a screen secured in tension to the perimeter member and the interior member and presenting a substantially flat sifting surface.

15. A sieve frame comprising:
a body structure including a perimeter member and an interior member constructed from a synthetic material, wherein the body structure is constructed from a single sheet of material into which is mechanically created one or more openings to define the perimeter member and the interior member; and
a screen secured in tension to the perimeter member and the interior member and presenting a substantially flat sifting surface.

16. A sieve frame comprising:
a body structure including a perimeter member and an interior member constructed from a synthetic material;
a first screen secured in tension to a first side of the body structure and presenting a substantially flat sifting surface; and
a second screen secured in tension to a second side of the body structure which is opposite the first side of the body structure, and the second screen having a larger micron size than the first screen.

17. An apparatus comprising:
a sieve box; and
a sieve frame installed within the sieve box, the sieve frame including
a body structure including a perimeter member and an interior member constructed from a synthetic material, and
a screen secured in tension to the perimeter member and the interior member and presenting a substantially flat sifting surface.

18. The apparatus as set forth in claim 17, wherein the perimeter member and the interior member are individual members that are assembled to form the body structure.

19. The apparatus as set forth in claim 18, wherein the individual members are adapted to positively engage each other.

20. The apparatus as set forth in claim 18, wherein the individual members are each a composite of a first layer of a first material and a second layer of a second material.

21. The apparatus as set forth in claim 17, wherein the body structure is constructed from a single sheet of material into which is mechanically created one or more openings to define the perimeter member and the interior member.

22. The apparatus as set forth in claim 21, wherein the single sheet of material is a composite of a first layer of a first material and a second layer of a second material.

23. The apparatus as set forth in claim 22, wherein the first layer and the second layer are secured together by a melted polyurethane film.

24. The apparatus as set forth in claim 17, wherein the screen is secured to the perimeter member and the interior member by a melted polyurethane film.

25. The apparatus as set forth in claim 17, wherein the body structure is substantially rectangular and presents a pair of spaced apart, parallel perimeter members, and wherein the apparatus further includes a spacing structure depending from the pair of spaced apart, parallel perimeter members to create a space between the sieve box and the sieve frame.

26. A sieve frame comprising:
a body structure including a pair of spaced apart, parallel perimeter members constructed from a synthetic material;
a screen secured in tension to the pair of spaced apart, parallel perimeter members; and
a spacing structure depending from the pair of spaced apart, parallel perimeter members.
